(19) United States
(12) Patent Application Publication
(10) Pub. No.: US 2021/0112832 A1
(43) Pub. Date: Apr. 22, 2021

(54) ANTRODIA CINNAMOMEA FERMENTED BROWN RICE, PREPARING METHOD AND COMPOSITION THEREOF

(71) Applicant: KANG JIANN BIOTECH CO., LTD., NANTOU COUNTY (TW)

(72) Inventors: LEAK-TEIK NG, TAIPEI CITY (TW); MING-NAN LAI, NANTOU COUNTY (TW); SHOU-CHOU LIU, NANTOU COUNTY (TW)

(21) Appl. No.: 17/136,540

(22) Filed: Dec. 29, 2020

Related U.S. Application Data
(63) Continuation of application No. 16/039,487, filed on Jul. 19, 2018.

(30) Foreign Application Priority Data
Dec. 29, 2017 (TW) 106146655

(51) Int. Cl. A23L 7/104; A23L 31/00; A23P 10/40; A23L 33/14

(52) U.S. Cl. CPC A23L 7/104; A23L 31/00; A23V 2002/00; A23L 33/14; A23P 10/40

(57) ABSTRACT

The present invention relates to Antrodia cinnamomea fermented brown rice, which is characterized by being produced by inoculating an A. cinnamomea strain in a medium composed of brown rice as cultivating substrate for fermentation. The A. cinnamomea fermented brown rice produced according to the present invention contains the special nutrients of brown rice and the unique active ingredients of A. cinnamomea. The A. cinnamomea fermented brown rice may be used as food material directly, and for the preparation of brown rice-based health products such as brown rice powder, brown rice milk, brown rice tea, and nutritious additives of other foods.

### CROSS-REFERENCE TO RELATED APPLICATION

This application is a continuation application of U.S. patent application Ser. No. 16/039,487, filed Jul. 19, 2018, entitled “ANTRODIA CINNAMOMEA FERMENTED BROWN RICE, PREPARING METHOD AND COMPOSITION THEREOF”, currently pending.

### FIELD OF THE INVENTION

The present invention relates to a brown rice fermented with Antrodia cinnamomea and a preparing method of the brown rice. Particularly, the present invention relates to a brown rice obtained by fermenting A. cinnamomea in a medium composed of brown rice as cultivating substrate.

### BACKGROUND OF THE INVENTION

Based on the historical records, Wu Sha was the pioneer of Ilan development in 1773 and he traded frequently with the local inhabitants after crossing the sea from Fujian of China to Taiwan. He also obtained A. cinnamomea from the local inhabitants and decocted it for consumption. Until 1985, A. cinnamomea has begun to spread more widely as food materials and was found to have good therapeutic efficacy; as a result, universities and public research institutions started actively investigating the phylogenetic relationships, chemical components, pharmacological activities and artificial cultivation methods of A. cinnamomea. Currently, the application potential of A. cinnamomea is highly recognized by the academic community. A. cinnamomea (also known as Antrodia camphorata and Taiwanofungus camphoratus), a perennial fungi, belongs to the family of Polyporales, Polyporaceae, Pleurotus, and Antrodia. Its common name is known as Zhang Zhi, Zhang mushroom, camphor mushroom, mushroom within camphor, stout camphor mushroom and red camphor mushroom, etc. A. cinnamomea is an endemic mushroom species of Taiwan and grows only in the hollow heartwood of the evergreen broadleaf tree species called Cinnamomum kanehirai, which is only found in Taiwan. Because of its scarcity and precious values, A. cinnamomea is therefore considered to be a treasure of the world.

Compounds contained in A. cinnamomea can be roughly classified into various classes such as polysaccharides, triterpenoids, diterpenes, sesquiterpenes, sesquiterpene lactones, benzenoids, benzoquinone derivatives, superoxide dismutase, polyacetylenes, adenosine, derivatives of maleic acid and succinic acid, proteins (including immune proteins), phenolic compounds, steroids, volatile substances (aroma of Antrodia), etc. Many of the firstly discovered components in A. cinnamomea were named by beginning with the prefix of Antrodia, such as antcin, antrocin, antrodin, antrocamphin, and antroquinonol. The fruiting bodies of A. cinnamomea cultivated via burdock wood or the A. cinnamomea mycelia of solid and liquid cultured have been found to have antioxidant, anti-inflammatory, hepatoprotective, anti-alcoholic hepatitis, anti-allergic, hypolipidemic, neuroprotective and anti-cancer effects.

Since 1991, investigations of A. cinnamomea started to develop and gradually receiving increasing attention after year 2000. Methods of artificial cultivation of A. cinnamomea include: (i) cultivating on burdock wood, of which the A. cinnamomea materials obtained are known to contain the components similar to those of the wild A. cinnamomea; (ii) solid-state and liquid culture methods, of which the solid-state culture method is also called polypropylene (PP) bag cultivation method. In PP bag cultivation method, A. cinnamomea strain is inoculated and cultivated in a PP bag containing fibers, sugars, grains and the like. Although the solid-state culture of A. cinnamomea can obtain components similar to those found in fruiting bodies of the wild A. cinnamomea, it takes about six months and the cost is slightly higher. The liquid culture method utilizes a fermenter through liquid fermentation to obtain A. cinnamomea mycelia. Although the liquid culture method has the advantage of short culture time (about 14 days), it is unable to obtain the unique triterpenoids and rare components commonly found in fruiting bodies of A. cinnamomea from the wilds. At present, most of the commercial A. cinnamomea products are derived from mycelia or fruiting bodies, which are produced by the liquid and/or solid fermentation methods, as for the purpose of not causing environmental problems associated with cutting down trees.

According to prior arts, some had attempted to inoculate A. cinnamomea strain into melon or fruit pulp materials for cultivation. For example, TW patent No. 1551683 discloses a method comprising inoculating A. cinnamomea in pulp of passion fruit, which was used as a culture substrate to improve the polysaccharide content of A. cinnamomea. TW patent No. 1551686 discloses a cultivation method for A. cinnamomea comprising inoculating A. cinnamomea into pumpkin, and then incubating at 24˜26° C. for 3˜6 weeks, such that the nutrients contained in the pumpkin is used for the growth of A. cinnamomea. However, so far there is no literature that discloses the utilization of single grain, especially brown rice, as the culture substrate of A. cinnamomea.

Rice is one of the staple food of more than half of the world's population. More than 90% of the rice planting area in the world is in “Asia”, where many rice-producing countries are located, and thus rice plays a very important role in the economy of these countries. Brown rice is a kind of rice produced by simple processing and shelling of rice, which still retains part of the outer tissues such as cortex, aleurone, and germ. 60%-70% of vitamins, minerals and essential amino acids in rice are gathered in the outer tissues. Brown rice contains about six times higher dietary fiber than white rice, and it can be used to prevent and relieve constipation. Thus, brown rice has always been regarded as a healthy food material. In addition, brown rice also contains unique and abundant tocopherols (Toc), tocotrienols (T3) and γ-oryzanol, and other functional ingredients such as γ-aminobutyric acid (GABA), vitamin B-complex, phytosterols, ferulic acid and polyphenols, which are known to have the properties of lowering blood lipids and cholesterols, preventing cardiovascular diseases, anti-oxidation and anti-cancer. Epidemiological or clinical studies have demonstrated that these functional ingredients contribute to different degrees of disease-preventing effects, such as improving physical fitness, regulating physiological functions, and promoting overall health and well-being.

TW patent No. 1331506 discloses a method for artificial cultivation of A. cinnamomea, comprising inoculating A. cinnamomea in a medium which contains grains such as white rice, millet, sorghum or wheat, and coconut water, root crops and other carbohydrates to produce A. cinnamomea fruiting bodies, as to replace the burdock wood as a nutrient source for cultivating A. cinnamomea. Although the method of this patent can shorten the cultivation time and save cost by using common cereal materials as a nutrient source of A. cinnamomea, the composition of the culture medium is complicated and cannot be used directly as a food material; the other disadvantages of this method is its long cultivation time (more than six months) and instability in the production of fruiting bodies. The present invention was the first to utilize brown rice as a nutrient substrate for cultivation of A. cinnamomea to produce A. cinnamomea fruiting bodies or alike substances in a short period of time. Besides containing a variety of special chemical components of A. cinnamomea, these materials also contain the major bioactive nutrients of brown rice. Furthermore, the A. cinnamomea fermented brown rice prepared according to the method of the present invention can also be used directly as a raw material for health foods, and as table foods after cooking.

### SUMMARY OF THE INVENTION

The present invention discovers that inoculating A. cinnamomea strain into a medium composed of brown rice as a nutrient substrate undergoes fermentation may produce fruiting bodies of A. cinnamomea. The A. cinnamomea fermented brown rice maintains the special nutrients of brown rice, such as tocopherols, tocotrienols and γ-oryzanol, and further contains the unique active ingredients of A. cinnamomea that includes 1,4-dimethoxy-2,3-methylenedioxy-5-methyl-benzene, antcin C, 2,2′,5,5′-tetramethoxy-3,4,3′,4′-bimethylenedioxy-6,6′-dimethyl-biphenyl, antcin H, dehydrosulphurenic acid, antrocamphin C, antcin B, antcin antcin A, 15-acetyldehydrosulfurenic acid and dehydroeburicoic acid, etc. which is proved by further analysis of the composition of the obtained A. cinnamomea fermented brown rice.

Accordingly, in one aspect, the present invention relates to A. cinnamomea fermented brown rice, which is characterized by being produced by performing fermentation of A. cinnamomea strain in a medium composed of brown rice as nutrient substrate, wherein the A. cinnamomea fermented brown rice includes special nutrients of brown rice and unique active ingredients of A. cinnamomea.

In certain embodiments of the invention, the A. cinnamomea fermented brown rice includes the special nutrients of the brown rice, such as tocopherols, tocotrienols, γ-oryzanol, and the like. In certain embodiments of the invention, the A. cinnamomea fermented brown rice includes the unique active ingredients of A. cinnamomea, such as including 1,4-dimethoxy-2,3-methylenedioxy-5-methyl-benzene, antcin C, 2,2′,5,5′-tetra-methoxy-3,4,3′,4′-bimethylenedioxy-6,6′-dimethyl-biphenyl, antcin H, dehydrosulphurenic acid, antrocamphin C, antcin B, antcin antcin A, 15-acetyldehydrosulfurenic acid, dehydroeburicoic acid, and the like.

In another aspect, the present invention relates to a method for preparing A. cinnamomea fermented brown rice, which includes inoculating A. cinnamomea strain into a culture substrate consisting of brown rice and water fermenting the A. cinnamomea strain in the culture substrate at a temperature of 21˜23° C. and a humidity of 65˜70% for 1-2 months or preferably 40 days until the culture substrate are completely covered with fruiting bodies of the A. cinnamomea, followed by harvesting the A. cinnamomea fermented brown rice.

In certain embodiments of the invention, the method further includes drying the harvested A. cinnamomea fermented brown rice under 70˜80° C. for 20˜30 hours, preferably under 70˜80° C. for 24 hours, or lyophilizing the harvested A. cinnamomea fermented brown rice. In other embodiments of the invention, the said method further includes grinding the dried A. cinnamomea fermented brown rice to obtain A. cinnamomea fermented brown rice powder. In some other embodiments, the said method further includes extracting the harvested A. cinnamomea fermented brown rice with water and alcohol, followed by filtrating to obtain A. cinnamomea fermented brown rice extract. In other embodiments of the invention, the said method further includes drying and grinding the concentrate of A. cinnamomea fermented brown rice extract to obtain an A. cinnamomea fermented brown rice extract powder

In another aspect, the present invention relates to a food composition that is characterized by comprising the A. cinnamomea fermented brown rice, or the A. cinnamomea fermented brown rice powder, or the A. cinnamomea fermented brown rice extract.

The A. cinnamomea strain used in the present invention includes A. cinnamomea BCRC 35396 (ATCC 200183), A. cinnamomea BCRC 36401 (TAM SL-7), A. cinnamomea KJ-HL, and the like.

### BRIEF DESCRIPTION OF THE DRAWINGS

FIG. 1 shows an analysis results of the special nutrients of the brown rice in the A. cinnamomea fermented brown rice prepared by an example of the invention.

FIG. 2A shows an analysis results of the active ingredients of the A. cinnamomea in the A. cinnamomea fermented brown rice prepared by an example of the invention.

FIG. 2B shows a sample of fermented brown rice without inoculation of A. cinnamomea strain (as a control, the fermentation conditions of the fermented brown rice were the same as those of the A. cinnamomea fermented brown rice in FIG. 2A).

FIG. 2C shows a sample of A. cinnamomea strain inoculated brown rice without fermentation (as a control, the fermentation conditions of the A. cinnamomea strain-inoculated brown rice were the same as those of the A. cinnamomea fermented brown rice in FIG. 2A).

FIG. 2D shows a blank sample.

### DETAILED DESCRIPTION OF THE PREFERRED EMBODIMENTS

As used herein, the term “brown rice” (also referred Genmi) means the parts of bran and germ retained after the shell of a rice grain being removed therefrom. The term “special nutrients of brown rice” refers to the functional ingredients beneficial to the body existing in brown rice, mainly including tocopherols (Toc), tocotrienols (T3), γ-oryzanol, γ-aminobutyric acid (GABA), ferulic acid, polyphenols, dietary fiber, and the like.

As used herein, the term “unique active ingredients of A. cinnamomea” refers to the components with specific medicinal physiological activity uniquely existing in A. cinnamomea, which mainly contains polysaccharides, triterpenes, diterpenes, sesquiterpenes, sesquiterpene lactones, benzenoids, benzoquinone derivatives, superoxide dismutases, polyacetylenes, adenosine, derivatives of maleic acid and succinic acid, proteins (including immunoproteins), phenolic compounds, steroids, and vitamins (e.g., vitamin B, nicotinic acid, etc.), trace elements (such as calcium, phosphorus, germanium, etc.), nucleic acids, amino acids, lignans, γ-aminobutyric acid (GABA), blood pressure stabilizing substances (such as antrodia acid), and the like.

The other characteristics and advantages of the present invention will be further illustrated and described in the following examples. The examples described herein are using for illustrations, not for limitations of the invention.

### EXAMPLE 1

### Preparation of Antrodia cinnamomea Fermented Brown Rice

Culture medium: brown rice was mixed with water at a ratio of 1:1.1 and placed in a jar. Each jar with the medium weighs about 100-120 g. The medium was sterilized at 121° C. for 1 hour. Inoculation: a 2 mm×3 mm cube form or liquid from and/or solid form of A. cinnamomea KJ-HL strain was inoculated into the above-mentioned sterilized medium. Culture conditions: temperature: 21-23° C., humidity: 65 to 70%, ventilation frequency: 5 min/12 hours, carbon dioxide concentration: 1000 to 2000 ppm, culture without light for 1 to 2 months

After 40 days of fermentation, the medium was well covered with the light reddish yellow fruiting bodies of A. cinnamomea. The A. cinnamomea fermented brown rice was harvested and dried with hot air at 70˜80° C. for 24 hours, or lyophilized for 48 hours to obtain the dried A. cinnamomea fermented brown rice. The obtained dried A. cinnamomea fermented brown rice may be directly used as a food material for cooking, or to be processed into cereal pieces, or can be used for making Genmi tea. The dried fermented brown rice may also be further ground into A. cinnamomea fermented brown rice powder and thus can be added to other ingredients or beverages as a nutrient blending agent, and made into healthy food composition such as healthy brown rice syrup, brown rice formulated milk, and brown rice cake, etc.

### EXAMPLE 2

### Preparation of Concentrate of the Antrodia cinnamomea Fermented Brown Rice Extract

The A. cinnamomea fermented brown rice obtained in Example 1 was extracted with water and alcohol at 95° C. for 5 hours to obtain A. cinnamomea fermented brown rice extract solution. The A. cinnamomea fermented brown rice extract solution was filtrated on a stainless steel mesh (150 mesh).

Then, the filtered A. cinnamomea fermented brown rice extract solution was transferred to a vacuum concentrator and concentrated at a temperature of 52±2° C. After the filtrate was concentrated to a concentration standard line, the concentrate was taken and placed into a fluidized-bed spray dryer to perform spray drying (temperature: 62±2° C., pump rotation speed: 35 rpm, wind turbine rotation speed: 40 rpm). The dried A. cinnamomea fermented brown rice extract was taken, ground (mesh size: 90 mesh) and sieved (mesh size: 60 mesh) to obtain the A. cinnamomea fermented brown rice extract powder.

### EXAMPLE 3

### Analysis of Special Nutrients of Brown Rice in the Antrodia cinnamomea Fermented Brown Rice

In order to determine whether the special nutrients are retained after fermentation with A. cinnamomea, an analysis for the active ingredients such as tocopherols, tocotrienols and γ-oryzanol in the A. cinnamomea fermented brown rice was conducted.

Extraction of Active Ingredients

Weigh 0.5 g of the A. cinnamomea fermented brown rice sample and mixed with 3 mL of n-hexane, the mixture was extracted by vortex vigorously for 20 minutes in a 60° C. water bath and then centrifuging at 2000 rpm for 15 min. After collecting the supernatant, the residue was further extracted in the same manner twice. Finally, the supernatants from the three separate extractions were combined and filtered through a 0.45 μM filter. The filtrate was collected for HPLC analysis (cf. Huang & Ng, Journal of Chromatography A 1218: 4709-4713, 2011).

Analysis of Active Ingredients

The High Performance Liquid Chromatography (HPLC) used in this example is a Hitachi system device, including: chromatographic pump (Model L-2100/2130), UV-visible spectroscopic detector (Model U-1800), and fluorescence detector (Model L-2485). The analysis of the active ingredients of the brown rice was performed using the fluorescence detector set at wavelengths of 290 nm (excitation wavelength) and 330 nm (emission wavelength). The analysis conditions are as follows: mobile phase: containing n-hexane, isopropanol, ethyl acetate, and acetic acid; analytical column: Inertsil SiL 100A, 5 μm, 4.6×250 mm; the flow rate of mobile phase: 0.7 mL/min.

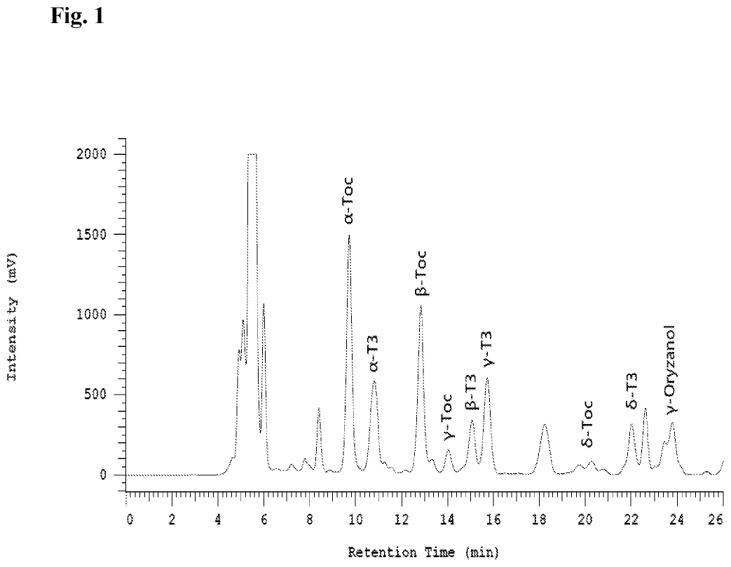

As shown in FIG. 1, the A. cinnamomea fermented brown rice of present invention retains the special nutrients of brown rice as analyzed by the HPLC after fermentation, and extraction with n-hexane. The special nutrients include tocopherols (α-tocopherol represented as α-Toc, β-tocopherol represented as β-Toc, γ-tocopherol represented as γ-Toc, and δ-tocopherol represented as δ-Toc in the figure), tocotrienols (α-tocotrienol represented as α-T3, β-tocotrienol represented as β-T3, γ-tocotrienol represented as γ-T3, and 6-tocotrienol represented as δ-T3 in the figure) and γ-oryzanol.

### EXAMPLE 4

### Analysis of Active Ingredients of Antrodia cinnamomea in the Antrodia cinnamomea Fermented Brown Rice

In order to determine whether the unique active ingredients are included, an analysis for the active ingredients such as triterpenes, non-triterpenoids like antcin C and phenols in the A. cinnamomea fermented brown rice was conducted.

Preparation of the extract for analysis: 20 mg of the A. cinnamomea fermented brown rice sample was placed in a 1.5 mL Eppendorf tube, followed by adding 0.8 mL of 95% alcohol (1:40, w/v) and mixed thoroughly. The mixture was shaken in an ultrasonic water bath at room temperature for 1 hour, and then centrifuged at 6000 rpm for 5 minutes. The supernatant was filtered through a 0.45 μm filter into a 1.5 mL Eppendorf tube, and then made into volume of 1 mL with 95% alcohol. The extract was stored at −20° C. until HPLC analysis (cf. Lin et al., Journal of Agricultural and Food Chemistry 59:7626-7635, 2011).

Conditions of HPLC analysis comprise of analytical column: Luna C18(2) (5 μm, 4.6×250 mm, Phenomenex); detection wavelength: 254 nm; mobile phase containing A: 0.1% acetic acid (H₂O with 0.1% (v/v) acetic acid), B: methanol (MeOH), and C: acetonitrile (ACN). The flow rate of mobile phase is shown in the following table.

| Time | A: H₂O | | | Flow rate |
|---|---|---|---|---|
| (min) | (0.1% Acetic acid) | B: MeOH | C: ACN | (mL/min) |
| 0 | 40 | 30 | 30 | 0.5 |
| 5 | 40 | 30 | 30 | 0.5 |
| 95 | 10 | 10 | 80 | 0.5 |
| 95.1 | | | | 1.0 |
| 105 | 0 | 0 | 100 | 1.0 |
| 115 | 0 | 0 | 100 | 1.0 |
| 118 | 40 | 30 | 30 | 1.0 |
| 120 | 40 | 30 | 30 | 1.0 |

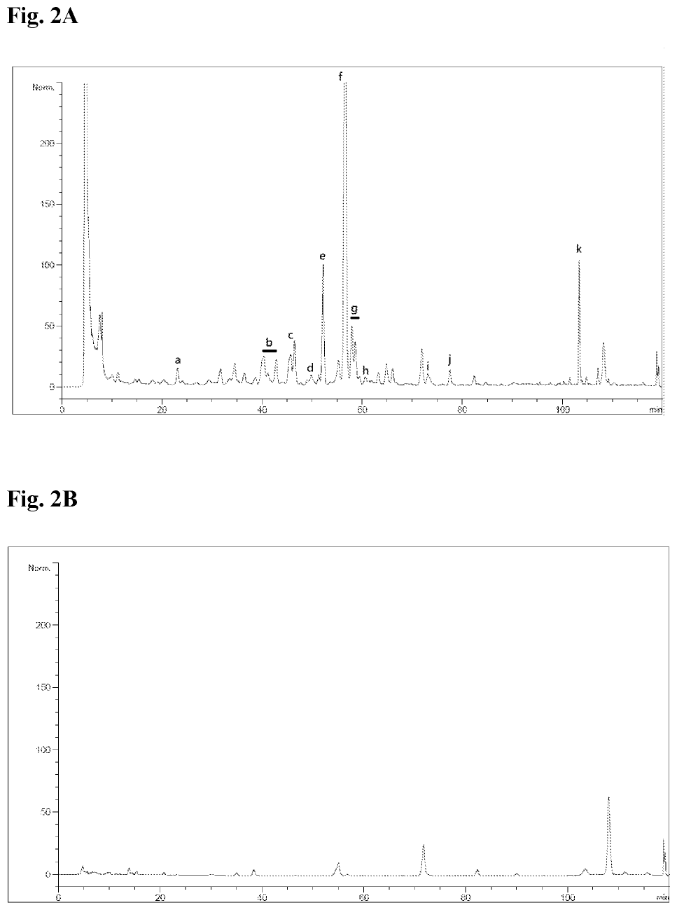

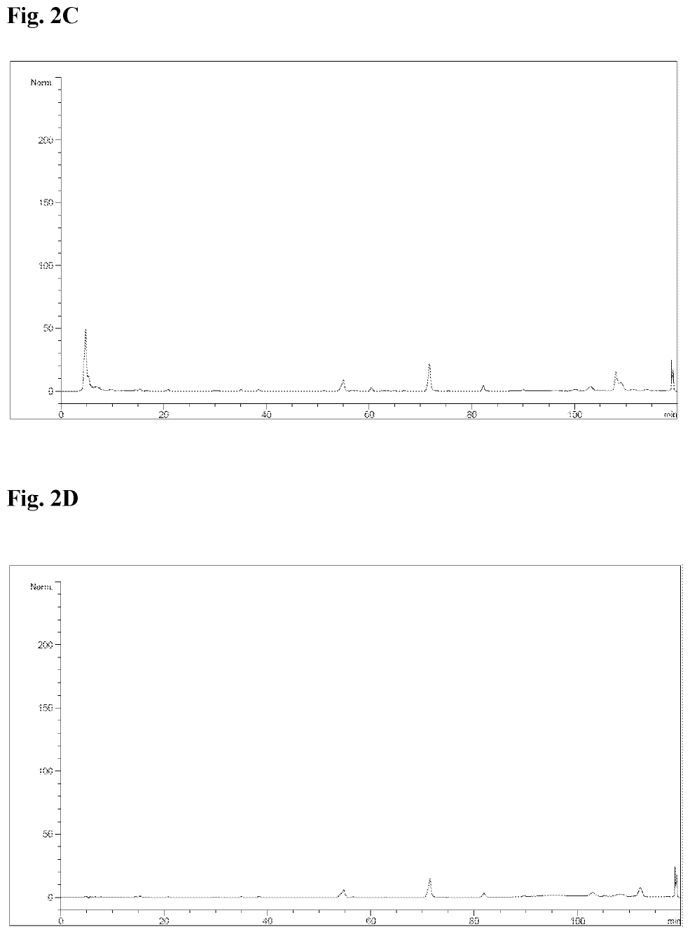

The analysis results were shown in FIG. 2A to 2D. FIG. 2A showed (in FIG. 2A, a: 1,4-Dimethoxy-2,3-methylenedioxy-5-methylbenzene, b: Antcin C, c: 2,2′,5,5′-Tetramethoxy-3,4,3′,4′-bimethylenedioxy-6,6′-dimethylbiphenyl), d: Antcin H, e: Dehydrosulphurenic acid, f: Antrocamphin C, g: Antcin B, h: Antcin Antcin A, j: 15-Acetyldehydrosulfurenic acid, and k: Dehydroeburicoic acid. That is, the A. cinnamomea fermented brown rice of the invention was confirmed to contain the unique active chemical markers of A. cinnamomea that includes 1,4-dimethoxy-2,3-methylenedioxy-5-methyl-benzene, antcin C, 2,2′,5,5′-tetramethoxy-3,4,3′,4′-bimethylenedioxy-6,6′-dimethylbiphenyl, antcin H, dehydrosulphurenic acid, antrocamphin C, antcin B, antcin antcin A, 15-acetyldehydrosulfurenic acid and dehydroeburicoic acid. Regarding the fermented brown rice (as a control, showed in FIG. 2B) and the A. cinnamomea inoculated brown rice (as a control, showed in FIG. 2C), the HPLC profiles of these controls and the blank sample indicated that there are no peaks of unique active ingredients of A. cinnamomea. The results suggest that, the unique active ingredients of A. cinnamomea contained in the A. cinnamomea fermented brown rice of the invention has to be produced by the fermentation process composing of brown rice and A. cinnamomea.

The present invention first utilizes brown rice as a nutrient substrate, to obtain the special nutrients of brown rice and unique active ingredients of A. cinnamomea through fermentation. The A. cinnamomea fermented brown rice can be directly used for cooking as food, since the medium used for fermenting A. cinnamomea fermentation is composed of brown rice that results in simple composition thereof. Furthermore, brown rice itself is a well-known food material having high nutritional value. After going through the fermentation process with A. cinnamomea, the A. cinnamomea fermented brown rice not only retain the special nutrients originally present in the brown rice, but also has the unique active ingredients of A. cinnamomea, thereby further enhancing its industrial value and breadth in the preparation of healthy products and nutraceuticals.

What is claimed is:

1. A method for preparing an A. cinnamomea fermented brown rice, comprising steps of:
inoculating A. cinnamomea strain into a sterilized culture substrate consisting of brown rice and water;
fermenting the A. cinnamomea strain and brown rice at a temperature of 21˜23° C. and a humidity of 65˜70% for 1-2 months until the brown rice is completely covered with fruiting bodies of the A. cinnamomea; and
harvesting the A. cinnamomea fermented brown rice.

2. The method of claim 1, wherein the culture substrate is a mixture consisting of brown rice and water at ratio of 1:1.1.

3. The method of claim 1, wherein the A. cinnamomea strain is inoculated into the culture substrate with a cube form of about 2 mm×3 mm, a liquid form or a solid form.

4. The method of claim 1, wherein the step of harvesting the A. cinnamomea fermented brown rice is carried out after 40 days of fermentation.

5. The method of claim 1, wherein the harvested A. cinnamomea fermented brown rice comprises nutrients of brown rice including tocopherols, tocotrienols, γ-oryzanol, and active ingredients of A. cinnamomea fruiting bodies including 1,4-dimethoxy-2,3-methylenedioxy-5-methyl-benzene, antcin C, 2,2′,5,5′-tetramethoxy-3,4,3′,4′-bimethylenedioxy-6,6′-dimethyl-biphenyl, antcin H, dehydrosulphurenic acid, antrocamphin C, antcin B, antcin antcin A, 15-acetyldehydrosulfurenic acid and dehydroeburicoic acid.

6. The method of claim 1, further comprising a step of drying the harvested A. cinnamomea fermented brown rice under 70˜80° C. for 20˜30 hours or lyophilizing the harvested A. cinnamomea fermented brown rice to obtain the dried A. cinnamomea fermented brown rice.

7. The method of claim 6, wherein the harvested A. cinnamomea fermented brown rice is dried with hot air under 70˜80° C. for 24 hours.

8. The method of claim 6, further comprising a step of grinding the dried Antrodia cinnamomea fermented brown rice to obtain the A. cinnamomea fermented brown rice powder.

9. The method of claim 1, further comprising a step of extracting the harvested A. cinnamomea fermented brown rice with water and alcohol, followed by filtration to obtain an A. cinnamomea fermented brown rice extract.

10. The method of claim 9, further comprising a step of concentrating the A. cinnamomea fermented brown rice extract to obtain a concentrate of A. cinnamomea fermented brown rice extract.

11. The method of claim 10, further comprising a step of spray drying and grinding the concentrate of A. cinnamomea fermented brown rice extract to obtain an A. cinnamomea fermented brown rice extract powder.

12. An A. cinnamomea fermented brown rice, which is characterized in that the brown rice is produced by the method of claim 1.

13. The A. cinnamomea fermented brown rice of claim 12, further comprising a step of drying the harvested A. cinnamomea fermented brown rice under 70˜80° C. for 20˜30 hours or lyophilizing the harvested A. cinnamomea fermented brown rice to obtain the dried A. cinnamomea fermented brown rice.

14. The A. cinnamomea fermented brown rice of claim 12, which is characterized in the method of claim 1, wherein the harvested A. cinnamomea fermented brown rice comprises nutrients of brown rice including tocopherols, tocotrienols, γ-oryzanol, and active ingredients of A. cinnamomea fruiting bodies including 1,4-dimethoxy-2,3-methylenedioxy-5-methyl-benzene, antcin C, 2,2′,5,5′-tetramethoxy-3,4,3′,4′-bimethylenedioxy-6,6′-dimethyl-biphenyl, antcin H, dehydrosulphurenic acid, antrocamphin C, antcin B, antcin antcin A, 15-acetyldehydrosulfurenic acid and dehydroeburicoic acid.

15. A food composition, which is characterized in that the composition comprising the A. cinnamomea fermented brown rice of the method of claim 1.
